(19) United States
(12) Patent Application Publication
(10) Pub. No.: US 2008/0083032 A1
(43) Pub. Date: Apr. 3, 2008

(54) Non-immediate process existence possibility display processing apparatus and method

(75) Inventor: Yuji Yamaoka, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/785,559

(22) Filed: Apr. 18, 2007

(30) Foreign Application Priority Data
Sep. 28, 2006 (JP) 2006-264864

(51) Int. Cl. G06F 12/14; H04N 7/16; G06F 3/048

(52) U.S. Cl. 726/22; 715/781; 726/26

(57) ABSTRACT

A non-immediate process existence possibility detection unit for a Web browser monitors existence of “non-immediate process” such as a timer setting, an embedded object, a high-sensitive event handler and the like, with respect to a Web page managed by a page management unit, based on management by respective processing units such as a timer management unit, an event handler management unit, and an embedded object processing and management unit. The non-immediate process existence possibility detection unit outputs “Non-immediate Process Existence Possibility=Yes” if “non-immediate process” is detected, or outputs “Non-immediate Process Existence Possibility=No” if the existence of “non-immediate process” is not detected, respectively. Based on this output result, a non-immediate process existence possibility management and display unit displays an icon showing “Yes” or “No” for the non-immediate process existence possibility in a display window for the Web page.

### CROSS-REFERENCE TO RELATED APPLICATION

This application claims priority from Japanese patent application Serial no. 2006-264864 filed Sep. 28, 2006, the contents of which are incorporated by reference herein.

### BACKGROUND OF THE INVENTION

1. Field of the Invention

The present invention relates to a display processing technique for an apparatus which performs a WWW (World Wide Web) document display process. More particularly, the present invention relates to a processing apparatus and a method of displaying a possibility in which a process, which is provided by a Web page displayed in one display window and occurs at an arbitrary timing independently of a user's intention, may occur while multiple Web pages are being displayed in multiple display windows respectively by a Web browser (hereinafter referred to as “non-immediate process”).

2. Description of the Related Art

Presently, on an apparatus referred to as “Web browser” which performs a WWW document display process, security of a user's works or operations on one Web page may be subjected to threats from other Web pages being displayed.

As one of such threats, there is known an attack method referred to as CSRF (Cross Site Request Forgery). The CSRF is a method of forging and sending requests across several Web sites for the purpose of causing damage to certain Web sites.

With this CSRF, it is possible to instruct the Web browser to send a request having freely specified parameter values for attached queries or forms, so to speak, from outside to a true Web site via a mechanism provided on an attacking Web page set up on one Web site by an attacker.

This means that information stored in the Web browser (for example, information used for user identification and authentication, session management and the like) is automatically sent out with a request transmission unintended by the user. For example, if the user is browsing a Web site performing the session management and the authentication by using Cookie information, the CSRF for sending the request having arbitrary parameters to the Web site can attack the Web site to cause damage to the user.

With FIGS. 10 to 13, the CSRF will be specifically described.

The user arrives at a Web site A (some_domain) while browsing the Internet. At this time, it is assumed that a Web page 90 shown in FIG. 10 is being displayed on the Web browser. Although the Web page shown in FIG. 10 seems to be an ordinary page displaying a link to a highly reliable “Ordering Site B”, a mechanism of executing the CSRF prepared by the attacker has been described in the Web page.

Since the link to the reliable ordering site B has been prepared on the Web page 90, the user uses this link to open a Web page 91 on the ordering site B, as shown in FIG. 11.

The Web page 91 on the ordering site B displayed in another window is surely on the reliable ordering site B, when judged from its URL (trusted_domain). Then, the user inputs his user ID and password to login the page. The ordering site B performs the session management and the user authentication by using the Cookie. On the ordering site B, after the user logins the page, it is assumed that the Web browser retains the Cookie for the session management and the user authentication to perform the session management and the user authentication only with this Cookie information.

FIG. 12 shows a Web page 92 displayed after the login, for ordering tasks on the ordering site B. An ordering form is prepared on the Web page 92. On the ordering site B, an order is confirmed by simultaneously sending the Cookie for the session management and the authentication as well as form data through the prepared ordering form.

The user inputs numbers at ordering number sections for respective products on the Web page 92. For example, it is assumed that the user inputted a number 1 only at the ordering number section for a product A (A=1). When an order confirmation button is clicked on, the Web browser sends a request (order processing request) attached with the Cookie for the session management and the authentication as well as the form data set to the number inputted by the user (A=1, B=0, C=0) to the ordering site B. This completes a task of “ordering one product A” based on the user's intention.

However, the Web page 92 displayed by the user is set as a target of the CSRF by the CSRF mechanism prepared on the Web page 90 being simultaneously displayed.

In other words, the Web page 90 uses the Cookie and the form data used by the Web page 92 to send a forged HTTP request (POST or GET) including the Cookie for the session management and the authentication retained by the Web browser as well as the form data with an any value (=9) specified (A=9, B=9, C=9), to the ordering site B.

Then, the ordering site B regards a received order request as an order from the user and completes the process. Then, the ordering site B sends an order confirmation response to the Web browser, where a Web page 93 as shown in FIG. 13 is displayed.

The order request forged by the Web page 90 is not intended by the user. However, when viewed from the ordering site B, the sent request has complete contents. Therefore, the ordering site B determines the request to be a legitimate order request from the user and confirms “an order for 9 pieces of each of the products A, B and C”.

A script on the Web page 90 can send such a request forging the order many times. Also, it is possible not to display the order confirmation response as shown in FIG. 13 on the Web page 93. For example, this can be performed by an operation such as rewriting href of a Link tag of HTML many times and the like. The user may not even notice that his order has been forged.

Measures against the CSRF performing such an attack are typically considered to be performed on the Web server side. For example, in the ordering process as described above, it is said to be effective to require not only the Cookie but also authentication data as the form data. However, the measures against the CSRF may not be sufficiently taken at many Web servers on the grounds that it is troublesome to take such measures and the like.

Consequently, also client side needs to take possible measures against the CSRF. Conventionally, since such a CSRF attack itself has not been well known, only such following measures have been taken at the client side (for example, refer to Non-patent Document 1: MicrosoftCorp. SupportHome document number J240797, http://support.microsoft.com/kb/240797, Apr. 14, 2006, Microsoft Corp.)

Measures 1: The Web browser is provided with a function of disabling a script or an object causing operations unintended by the user. The Web browser has been set to constantly disable a script such as JavaScript (registered trademark) or an embedded object such as JavaApplet (registered trademark) (hereinafter referred to as “script or the like”), or to display a dialog for asking whether to enable such relevant script or the like if any, so that the script or the like may not operate.

Measures 2: The Web browser is provided with a function capable of configuring settings for enabling/disabling the script or the like to be automatically switchable for each domain (URL).

The CSRF attack is performed by using “non-immediate process” which occurs at an arbitrary timing independently of the user's intention. Therefore, it is important for the user to consciously control to enable/disable the script or the like capable of performing the non-immediate process. For example, as conventional Measures 1, it is conceivable that the displayed dialog for enabling the script or the like (making them operable) can raise the user's risk awareness with respect to the threats.

However, in Measures 1, the dialog has asked the user for his permission to enable the script or the like each time even on the Web page of a reliable site, which has been problematically cumbersome for the user of the Web browser.

Also, convenience in the operations or the works at the Web site and robustness to the CSRF attack are in a trade-off relationship. It is conceivable that many users hope to use the Web browser with the setting for enabling the script or the like in the meantime, on a Web page having an undeterminable degree of risk of the CSRF attack.

The user has to be constantly conscious of the risk of the CSRF attack on the Web page once having the setting for enabling the script or the like. In addition, also with respect to other display windows, the user has to proceed the operations or the works while continuously remembering that he has set the permission to enable the script or the like, which is also cumbersome for the user.

Moreover, each time a Web site determined to be reliable by the user is added, Measures 2 requires the user to explicitly and additionally set the Web site, which causes a problem of such a troublesome setting operation. For example, the user has to explicitly set the URL of the reliable site in a list and the like, which forces the user to perform such a troublesome operation.

When using the Web browser in such a status, if multiple Web pages are being displayed on the Web browser, the user needs to be constantly conscious of whether a function of enabling the CSRF attack exists, and whether to permit such a function to operate, with respect to all Web pages including other Web pages, in addition to the Web page on which the user is currently operating or working. However, it is practically difficult to rely on the user's memory or consciousness, and it is also difficult to expect the user to frequently change the setting of the permission for the script or the like depending on a degree of risk of the Web page. Therefore, a mechanism of making the user constantly conscious of whether or not the non-immediate process for enabling the CSRF attack exists is required.

### SUMMARY OF THE INVENTION

It is an object of the present invention to provide a Web browser function of monitoring whether or not “non-immediate process” that causes contents which are of no concern and unknown to a user, for example, such as a forged request transmission, exists in a Web page being displayed in a display window, and if its possibility is detected, displaying “non-immediate process existence possibility” in the display window so that the user can more easily be conscious of risk of CSRF.

The present invention is preferably incorporated in an apparatus which performs a WWW document display process (Web browser). The present invention is characterized in that if a possibility of existence of “non-immediate process”, which is caused by the Web page displayed in the above described display window and performs a predetermined process at an arbitrary timing independently of the user's intention, (non-immediate process existence possibility) is detected, a result of the detection is displayed on the Web page being operated by the user.

The present invention is a program product for causing an apparatus which performs a WWW document display process to execute 1) a detection process of detecting a predetermined element capable of performing a non-immediate process that executes a process having contents unintended by a user at an arbitrary timing, from an obtained Web page, and 2) a display process of, if the above described element has been detected from the above described Web page, displaying a non-immediate process existence possibility in a display window in which the above described Web page is being displayed.

Moreover, if there are multiple Web pages being displayed, the present invention can detect the above described element for each Web page in the above described detection process. In addition, in the above described display process, the present invention can display the non-immediate process existence possibility in the above described display window for each of a Web page operated by the above described user and other Web pages among the above described multiple Web pages.

Alternatively, if there are multiple Web pages being displayed, the present invention can detect the above described element for each Web page in the above described detection process. In addition, in the above described display process, the present invention can display the non-immediate process existence possibility for each of the above described multiple Web pages in the above described display window.

Furthermore, the present invention may cause the above described apparatus to execute a detection target non-immediate process target setting process of setting the predetermined element capable of performing the non-immediate process that executes the process having the contents unintended by the user at the arbitrary timing, which is detected in the above described detection process, based on information inputted by the user.

The present invention operates as follows.

With the detection process, an apparatus which executes the present invention detects the predetermined element capable of performing the non-immediate process that executes the process having the contents unintended by the user at the arbitrary timing, for example, such an element as a timer, an embedded object, a high-sensitive event handler or the like, from the Web page being displayed in the apparatus which performs the WWW document display process. Then with the display process, if such an element has been detected from the Web page, a mark showing the non-immediate process existence possibility is displayed in the display window in which the Web page is being displayed.

Moreover, if the Web pages are displayed in multiple windows on the Web browser, with the above described detection process, the element capable of performing the non-immediate process is detected for each Web page. Then with the above described display process, the non-immediate process existence possibility is displayed in the display window for each of the Web page operated by the above described user and other Web pages among the above described multiple Web pages. Alternatively, the non-immediate process existence possibility for each of the multiple Web pages is displayed.

Moreover, the present invention is a processing apparatus for performing the above described process. In addition, the present invention is a processing method performed by the apparatus which performs the WWW document display process, for realizing the above described process.

Moreover, the present invention is a program read and executed by a computer that is the apparatus which performs the WWW document display process, and can be stored in appropriate recording media such as a computer-readable portable medium memory, a semiconductor memory, a hard disk and the like, and is recorded and provided in these recording media or provided through transmissions using various communication networks via communication interfaces.

In order to let the user recognize a possibility of a CSRF attack caused by the Web page provided by the WWW, the present invention can monitor whether or not the non-immediate process capable of functioning as the CSRF exists in the displayed Web page. As the possibility of the existence of the non-immediate process, the present invention can detect whether or not the predetermined element, for example, such as the timer, the embedded object, the high-sensitive event handler or the like, exists in the displayed Web page, and if its existence has been detected, the present invention can display that there is “non-immediate process existence possibility”, in the display window for the Web page.

According to the present invention, it is possible to present to the user that there is risk of “non-immediate process” with a fraudulent intention potentially existing in the Web page. Therefore, it is possible to let the user maintain risk awareness with respect to the possibility of the CSRF attack, without displaying a dialog to cause the user to set something or without causing the user to set a URL of a predetermined site.

In addition, according to the present invention, “non-immediate process existence possibility” can be separately displayed for the Web page on which the user is operating and for other Web pages. Therefore, even if the user is operating or working on a Web page on a reliable site, the user can recognize a possibility of receiving the CSRF attack from other Web pages being displayed, which can be expected to cause the user to take defensive measures such as closing unnecessary Web pages and the like.

### BRIEF DESCRIPTION OF THE DRAWINGS

FIG. 1 shows a configuration example in an embodiment of the present invention;

FIG. 2 shows an example of a specification screen for causing a user to specify an embedded object out of a detection target for a non-immediate process existence possibility;

FIG. 3 is a flowchart of a process from communicating a Web page until displaying it;

FIG. 4 is a flowchart of a non-immediate process existence possibility detection process;

FIG. 5 shows a flowchart of an embedded object existence determination process;

FIGS. 6 and 7 show flowcharts of the non-immediate process existence possibility display process;

FIGS. 8A, 8B, 8C, 9A and 9B show examples of displaying the non-immediate process existence possibility; and

FIGS. 10 to 13 are diagrams for illustrating CSRF.

### DETAILED DESCRIPTION OF THE PREFERRED EMBODIMENTS

Hereinafter, the best mode for carrying out the present invention will be described.

In Web pages displayed based on HTML documents obtained from the WWW, there are several mechanisms of realizing a process corresponding to “non-immediate process”. In this embodiment, the following three functions are search targets as mechanisms of enabling the non-immediate process in existing major Web browsers.

(1) Timer

A timer is a specification for causing the Web browser to perform some sort of process after a certain period of time. For example, “refresh” specified at http-equiv attribute of a meta tag of HTML can cause the Web browser to request a specified URL after a specified time period has elapsed. For example, using an API (Application Program Interface) with “window.setTimeout (script, msec) in JavaScript” can cause the Web browser to start executing a specified process (script) after a specified time period (msec).

(2) Embedded Object

An embedded object is an arbitrary program or data specified with an object tag and the like of HTML. For example, “JavaApplet” specified with an applet tag of HTML can cause an arbitrary URL to be requested at an arbitrary timing by a Java program.

(3) High-Sensitive Event Handler

A high-sensitive event handler is a handler for responding events occurring independently of a user's intention, among event handlers for scripts such as JavaScript and the like. For example, “onMouseOver event handler (attribute)” specified at a body tag of HTML can cause an arbitrary script to be executed only when a mouse pointer just passes through a window being displayed.

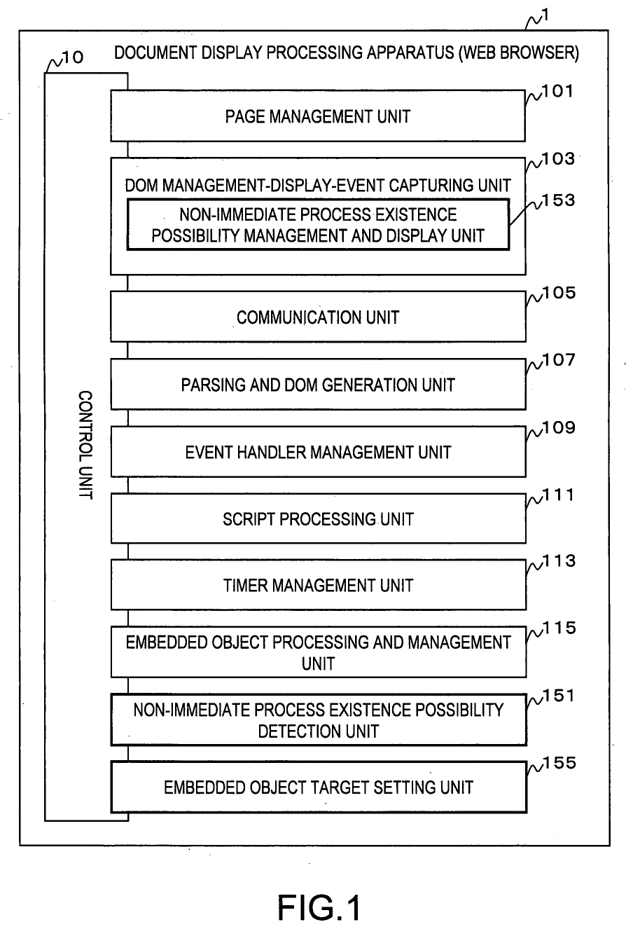

FIG. 1 shows a configuration example in an embodiment of the present invention.

A document display processing apparatus (Web browser) 1 is a processing apparatus for processing HTTP protocol communications, displaying an obtained Web page, and also displaying a possibility of a predetermined non-immediate process existing in the Web page, in a display window for the Web page.

The Web browser 1 includes a control unit 10, a page management unit 101, a DOM management-display-event capturing unit 103, a communication unit 105, a parsing and DOM generation unit 107, an event handler management unit 109, a script processing unit 111, a timer management unit 113, an embedded object processing and management unit 115, a non-immediate process existence possibility detection unit 151, a non-immediate process existence possibility management and display unit 153, and an embedded object target setting unit 155.

The non-immediate process existence possibility management and display unit 153 is provided as inner configuration means of the DOM management-display-event capturing unit 103.

Characteristics of the present invention are mainly realized by the non-immediate process existence possibility detection unit 151 and the non-immediate process existence possibility management and display unit 153.

The control unit 10 controls the following respective processing units.

The page management unit 101 manages the Web page being displayed in each display window of the Web browser 1. The page management unit 101 manages the Web page being displayed in the display window with page identification information (Page ID).

The DOM management-display-event capturing unit 103 manages a DOM (Document Object Model) of the Web page managed by the page management unit 101, displays a current DOM of the Web page in the display window, and captures the event occurring in the display window.

The communication unit 105 performs HTTP communications with a server.

The parsing and DOM generation unit 107 parses the HTML documents obtained by the communication unit 105 and generates the DOM.

The event handler management unit 109 uses the page identification information (Page ID) of the page management unit 101 to manage what kind of event handler exists in each Web page.

The script processing unit 111 interprets and evaluates the scripts such as JavaScript and the like contained or specified in the HTML document.

The timer management unit 113 manages a timer specification specified in the HTML document, the script or the like. At the time specified by each timer, previously specified communications or processes are executed by the communication unit 105, the script processing unit 111 and the like.

The embedded object processing and management unit 115 manages the embedded object specified in the HTML document, and causes a relevant processing system (not shown) to execute the process of the embedded object.

The non-immediate process existence possibility detection unit 151 monitors the processes by the timer management unit 113, the embedded object processing and management unit 115, the event handler management unit 109 and the like, and detects a possibility of the non-immediate process such as the timer, the embedded object, the high-sensitive event handler or the like existing in the Web page (non-immediate process existence possibility), based on processing operations of the respective processing units.

The non-immediate process existence possibility detection unit 151 detects the non-immediate process existence possibility if any of the following high-sensitive event handlers exists among the event handlers managed by the event handler management unit 109.

(1) Handlers for events occurring by mouse operations, including, for example, onClick (when a mouse was clicked on), onDblClick (when the mouse was double-clicked), onMouseDown (when a mouse button was depressed), onMouseUP (when the mouse button was released), onMouseOver (when a mouse cursor was positioned on the object), onMouseOut (when the mouse cursor left the object), and onMouseMove (when the mouse cursor moved).

(2) Handlers for events occurring by keyboard operations, including, for example, onKeyDown (when a key was depressed), onKeyPress (when the key was being depressed for a while), and onKeyUp (when the depressed key was released).

(3) Handlers for events occurring when the Web page is cleared, including, for example, onUnload (when the page is closed).

(4) Handlers for events related to a focus, including, for example, onFocus (when its part obtained the focus (the part became selected)), and onBlur (when its part lost the focus).

(5) Handlers for events of changing the position or the size of the display windows, including, for example, onResize (when the size of the display window was changed), and onMove (when the display window was moved).

(6) Handlers for events related to selection in the display window, including, for example, onSelect (for example, a text was selected).

These event handlers may occur with the mouse operations and the key operations by the user, for example, when the user switches the display window (active display window) to be operated, or changes the position or the size of the display window.

Also, the non-immediate process existence possibility detection unit 151 detects the non-immediate process existence possibility if a predetermined embedded object exists in embedded objects managed by the embedded object processing and management unit 115. The embedded object to be selected as a detection target is an object other than that specifying only predetermined data or that explicitly specified as out of the detection target by the user with the embedded object target setting unit 155. For example, the embedded object having no classid attribute at the object tag specifies the data only, and therefore has no possibility of the non-immediate process depending on a specified data type, and is not necessary to be selected as the detection target.

The non-immediate process existence possibility management and display unit 153 displays the non-immediate process existence possibility in each display window.

The embedded object target setting unit 155 sets the embedded object to be selected as the detection target for the non-immediate process existence possibility by the non-immediate process existence possibility detection unit 151, based on information inputted by the user.

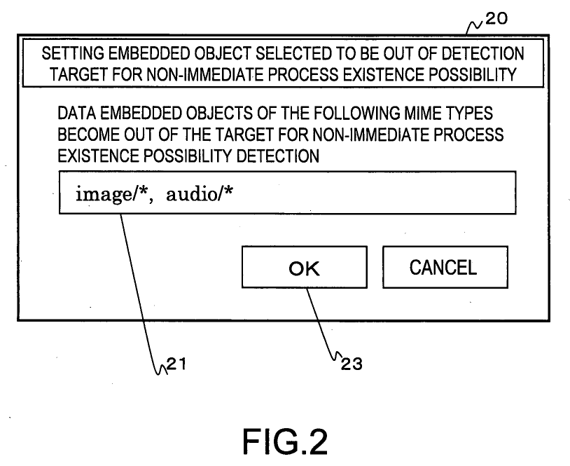

FIG. 2 shows an example of a screen 20 for causing the user to specify the embedded object out of the detection target for the non-immediate process existence possibility. At an input area 21 on the screen 20, when the user inputs a specification of data kinds of the embedded object of a MIME type and clicks on an OK button 23, the embedded object specifying the inputted data kinds is set to be out of the detection target for the non-immediate process existence possibility. These data kinds set to be out of the detection target are notified to the non-immediate process existence possibility detection unit 151.

The non-immediate process existence possibility detection unit 151 determines that there is no possibility of the non-immediate process if the embedded object managed by the embedded object processing and management unit 115 corresponds to that specifying the MIME type of the notified data kinds.

Next, a process flow of the present invention will be described.

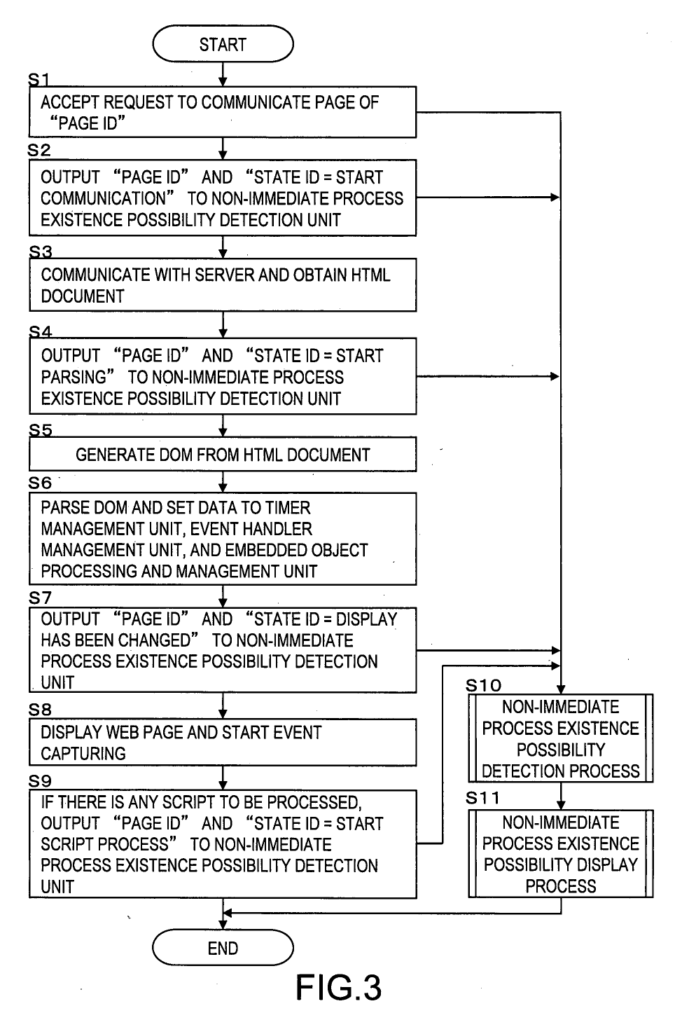

FIG. 3 is a flowchart of a process from communicating the Web page until displaying it on the Web browser 1.

The page management unit 101 of the Web browser 1 accepts a request to communicate the Web page specified with the Page ID (step Si). The control unit 10 sets a State ID=Start Communication, and outputs “Page ID” and “State ID=Start Communication” to the non-immediate process existence possibility detection unit 151 (step S2).

The non-immediate process existence possibility detection unit 151 accepts “Page ID” and “State ID”, and performs a non-immediate process existence possibility detection process (step S10). Contents of the process will be described later.

The communication unit 105 communicates with a requested server (step S3).

After the communication, the control unit 10 sets the State ID=Start Parsing, and outputs “Page ID” and “State ID=Start Parsing” to the non-immediate process existence possibility detection unit 151 (step S4).

The parsing and DOM generation unit 107 generates the DOM from the HTML document (step S5). Furthermore, the parsing and DOM generation unit 107 parses the DOM, and sets respective data to the timer management unit 113, the event handler management unit 109, and the embedded object processing and management unit 115 (step S6).

For setting the data to the timer management unit 113, for example, the parsing and DOM generation unit 107 searches an element having “refresh” specified at an http-equiv attribute of the meta tag from the DOM, and if any, sets its content attribute value as a timer for requesting to the specified URL after the elapse of the specified time period. It should be noted that the data setting to the timer management unit 113 is also performed on invoking predetermined APIs (for example, window.setTimeout ( . . . ), window.setInterval ( . . . ) and the like) by the script processing unit 111.

Also, for setting the data to the event handler management unit 109, the parsing and DOM generation unit 107 searches an element having an event handler attribute from the DOM and sets its contents. In addition, for setting the data to the embedded object processing and management unit 115, the parsing and DOM generation unit 107 obtains the embedded objects specified with respective tags “object”, “applet” and “embed”, and sets the obtained objects.

The control unit 10 sets the State ID=Display Has Been Changed, and outputs “Page ID” and “State ID=Display Has Been Changed” to the non-immediate process existence possibility detection unit 151 (step S7).

The DOM management-display-event capturing unit 103 displays the Web page in the display window based on the DOM and starts the event capturing (step S8).

Then, if there is any script to be executed by the event handler managed by the event handler management unit 109, prior to processing the script by the script processing unit 111, the control unit 10 sets the State ID=Start Script Process, and outputs “Page ID” and “State ID=Start Script Process” to the non-immediate process existence possibility detection unit 151 (step S9).

With the processes at steps S2, S4 and S7 or S9, if “Page ID” and “State ID” are outputted, the non-immediate process existence possibility detection unit 151 performs the non-immediate process existence possibility detection process (step S10). It should be noted that the order of the processes at steps S2, S4 and S7 or S9 is not limited to that shown in FIG. 3, and “Page ID” and “State ID” are outputted depending on the relevant process.

Then, the non-immediate process existence possibility management and display unit 153 receives an output from the non-immediate process existence possibility detection unit 151 and performs a non-immediate process existence possibility display process (step S11).

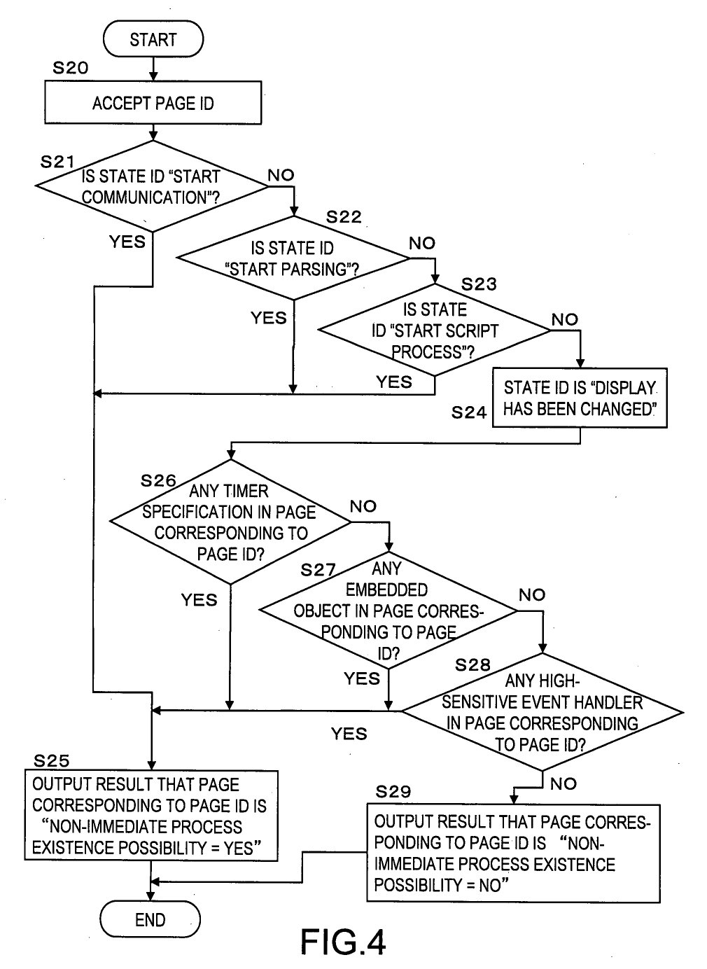

FIG. 4 shows a flowchart of the non-immediate process existence possibility detection process at step S10.

The non-immediate process existence possibility detection unit 151 accepts the Page ID (step S20). Furthermore, the non-immediate process existence possibility detection unit 151 determines the setting of the State ID (steps S21 to S24).

If the State ID is “Start Communication” (YES at step S21), the non-immediate process existence possibility detection unit 151 outputs a result that the Web page corresponding to the Page ID is “Non-immediate Process Existence Possibility=Yes” (step S25). Alternatively, if the State ID is “Start Parsing” (YES at step S22), the non-immediate process existence possibility detection unit 151 outputs the result that the Web page corresponding to the Page ID is “Non-immediate Process Existence Possibility=Yes” (step S25). Alternatively, if the State ID is “Start Script Process” (YES at step S23), the non-immediate process existence possibility detection unit 151 outputs the result that the Web page corresponding to the Page ID is “Non-immediate Process Existence Possibility=Yes” (step S25).

Alternatively, if the State ID is not set to any of “Start Communication”, “Start Parsing” and “Start Script Process” (No at steps S21, S22 and S23), it corresponds to “State ID=Display Has Been Changed” (step S24), and this process proceeds to step S26.

Then it is determined whether or not there is any timer specification in the Web page corresponding to the Page ID (step S26). If there is any timer specification (YES at step S26), the non-immediate process existence possibility detection unit 151 outputs the result that the Web page corresponding to the Page ID is “Non-immediate Process Existence Possibility=Yes” (step S25).

Alternatively, if there is no timer specification (NO at step S26), it is determined whether or not there is any predetermined embedded object in the Web page corresponding to the Page ID (step S27). If there is any predetermined embedded object (YES at step S27), the non-immediate process existence possibility detection unit 151 outputs the result that the Web page corresponding to the Page ID is “Non-immediate Process Existence Possibility =Yes” (step S25). In addition, an embedded object existence determination process will be described later.

Alternatively, it is determined whether or not there is any predetermined high-sensitive event handler in the Web page corresponding to the Page ID (step S28). If there is any predetermined high-sensitive event handler (YES at step S28), the non-immediate process existence possibility detection unit 151 outputs the result that the Web page corresponding to the Page ID is “Non-immediate Process Existence Possibility=Yes” (step S25).

Alternatively, if there is not any of the timer specification, the embedded object and the high-sensitive event handler in the Web page corresponding to the Page ID (NO at steps S26, S27 and S28), the non-immediate process existence possibility detection unit 151 outputs a result that the Web page corresponding to the Page ID is “Non-immediate Process Existence Possibility=No” (step S29).

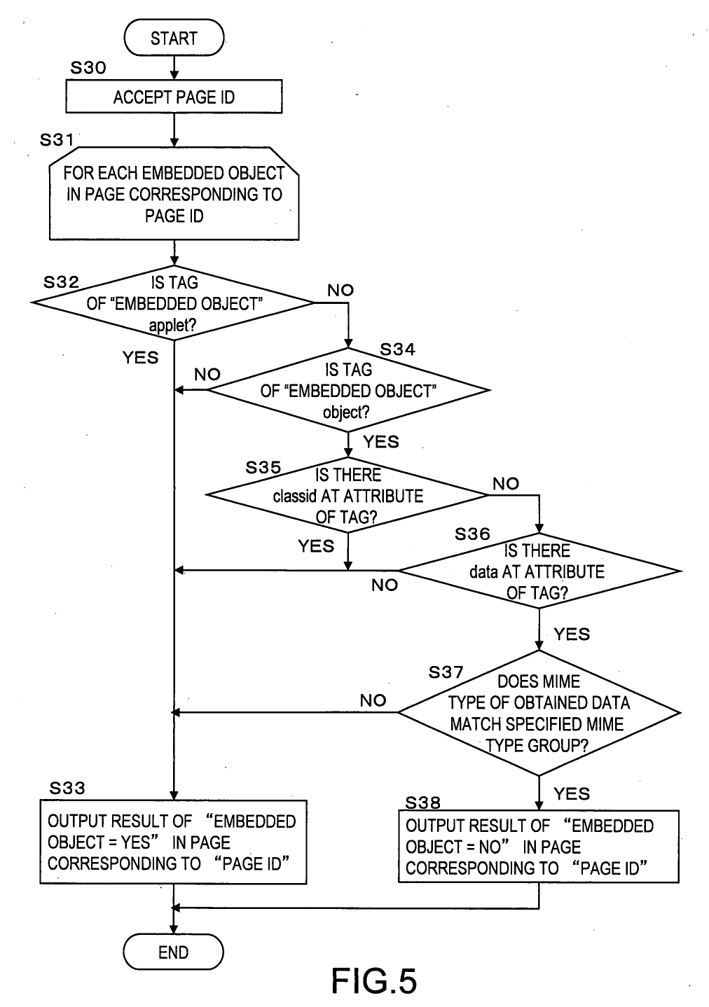

FIG. 5 shows a flowchart of the embedded object existence determination process at step S27.

The non-immediate process existence possibility detection unit 151 accepts the Page ID (step S30), and repeats the process of step S32 and later for each embedded object in the Web page corresponding to the Page ID (step S31).

First, it is determined whether or not the tag of the embedded object is “applet” (step S32), and if the tag of the embedded object is “applet” (YES at step S32), the non-immediate process existence possibility detection unit 151 outputs a result of “Embedded Object=Yes” in the Web page corresponding to the Page ID (step S33).

If the tag of the embedded object is not “applet” (NO at step S32), it is determined whether or not the tag of the embedded object is “object” (step S34). If the tag of the embedded object is “object” (YES at step S34), it is further determined whether or not there is “classid” at the attribute of the tag (step S35). If there is “classid” at the attribute of the tag (YES at step S35), the non-immediate process existence possibility detection unit 151 outputs the result of “Embedded Object=Yes” in the Web page corresponding to the Page ID (step S33).

Alternatively, if there is not “classid” at the attribute of the tag (NO at step S35), it is further determined whether or not there is “data” at the attribute of the tag (step S36). If there is not “data” at the attribute of the tag (NO at step S36), the non-immediate process existence possibility detection unit 151 outputs the result of “Embedded Object=Yes” in the Web page corresponding to the Page ID (step S33). On the other hand, if there is “data” at the attribute of the tag (YES at step S36), it is further determined whether or not the MIME type of the obtained data matches any of a MIME type group specified by the embedded object target setting unit 155 (step S37).

If the MIME type of the obtained data does not match any of the MIME type group specified by the embedded object target setting unit 155 (NO at step S37), the non-immediate process existence possibility detection unit 151 outputs the result of “Embedded Object=Yes” in the Web page corresponding to the Page ID (step S33). On the other hand, if the MIME type of the obtained data matches any of the specified MIME type group (YES at step S37), the non-immediate process existence possibility detection unit 151 outputs a result of “Embedded Object=No” in the Web page corresponding to the Page ID (step S38).

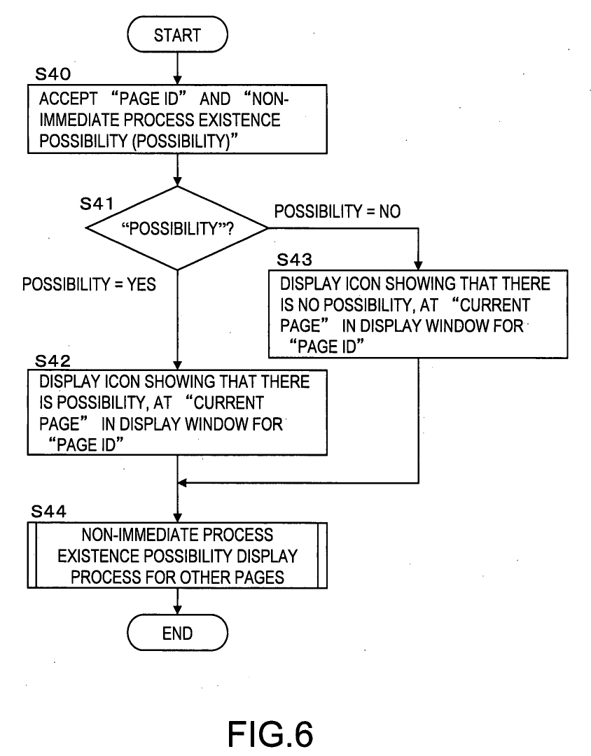

FIG. 6 shows a flowchart of the non-immediate process existence possibility display process.

The non-immediate process existence possibility management and display unit 153 accepts “Page ID” and “Non-immediate Process Existence Possibility (Possibility)” (step S40), and determines the setting of “Non-immediate Process Existence Possibility” (step S41).

If it is determines to be “Non-immediate Process Existence Possibility=Yes” (step S41), the non-immediate process existence possibility management and display unit 153 displays that “There is Non-immediate Process Existence Possibility (There is Possibility)” at a section of “Current Page (relevant page)” in the display window for the Web page corresponding to the Page ID (step S42). If it is determined to be “Non-immediate Process Existence Possibility=No” (step S41), the non-immediate process existence possibility management and display unit 153 displays that “There is no Non-immediate Process Existence Possibility (There is no Possibility)” at the section of “Current Page (relevant page)” in the display window for the Web page corresponding to the Page ID (step S43).

Furthermore, the non-immediate process existence possibility display process is repeated for other Web pages (step S44).

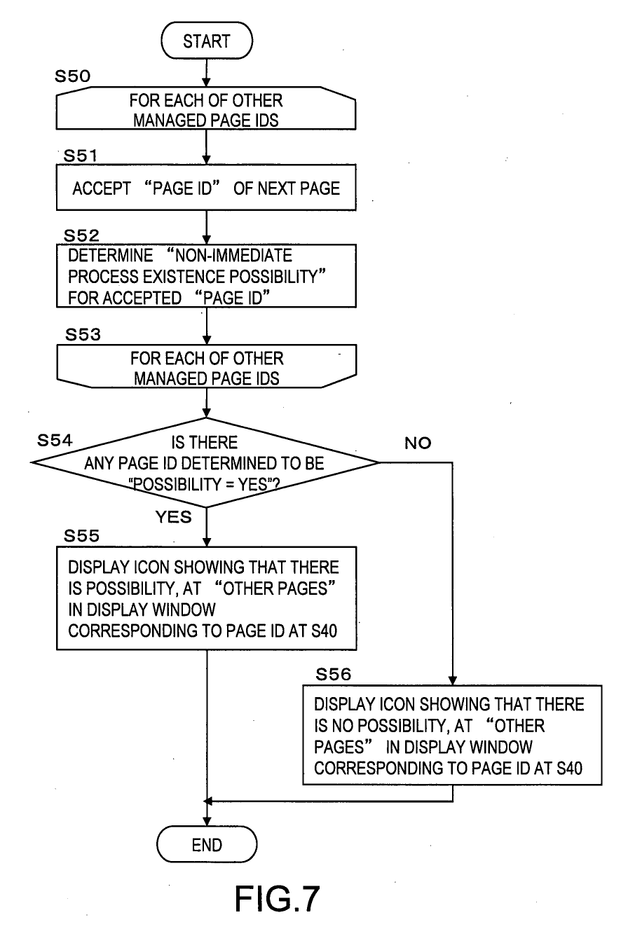

FIG. 7 shows a flowchart of the non-immediate process existence possibility display process for other Web pages at step S44.

The non-immediate process existence possibility management and display unit 153 performs the process at steps S51 and S52, with respect to Web pages corresponding to remaining Page IDs managed by the page management unit 101 (step S50). The non-immediate process existence possibility management and display unit 153 accepts the next Page ID in the managed Web pages (step S51), and determines “Non-immediate Process Existence Possibility” for the Web page corresponding to the accepted Page ID (step S52).

When the process is completed with respect to the remaining Page IDs managed by the page management unit 101 (step S53), if there is any Web page determined to be “Non-immediate Process Existence Possibility=Yes” among the remaining Web pages (YES at step S54), the non-immediate process existence possibility management and display unit 153 displays that “There is Possibility” at a section of “Other Pages” in the display window for the Page ID accepted at step S40 (step S55). On the other hand, if there is no Web page determined to be “Non-immediate Process Existence Possibility=Yes” among the remaining Web pages (NO at step S54), the non-immediate process existence possibility management and display unit 153 displays that “There is no Possibility” at the section of “Other Pages” in the display window for the Page ID accepted at step S40 (step S56).

It should be noted that the non-immediate process existence possibility management and display unit 153 may display that “There is Possibility/There is no Possibility” for each of other Web pages.

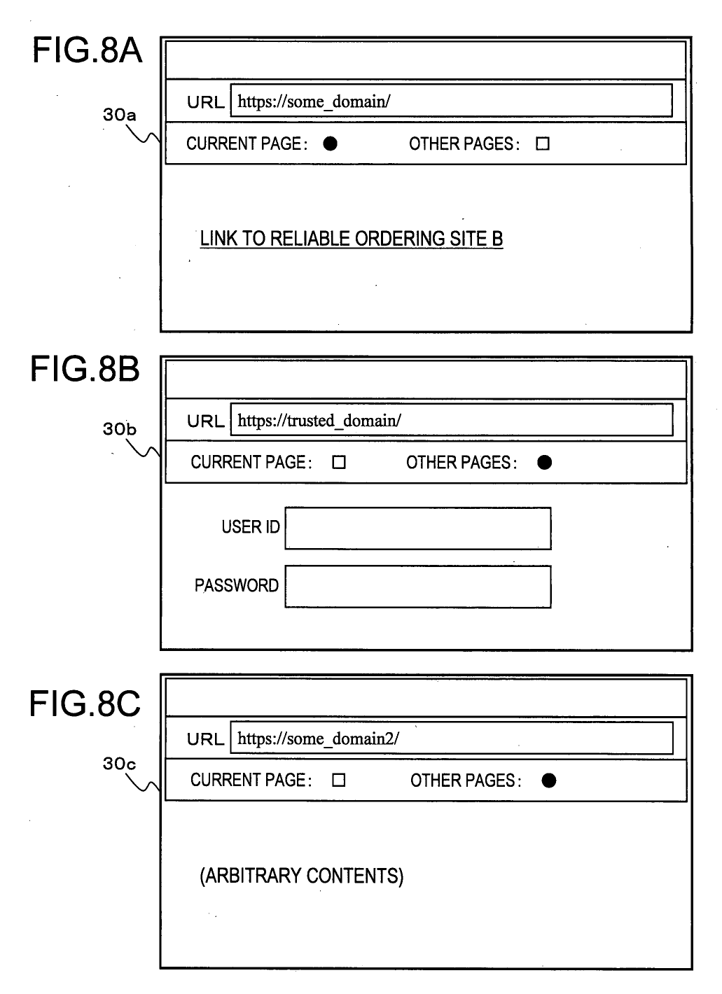

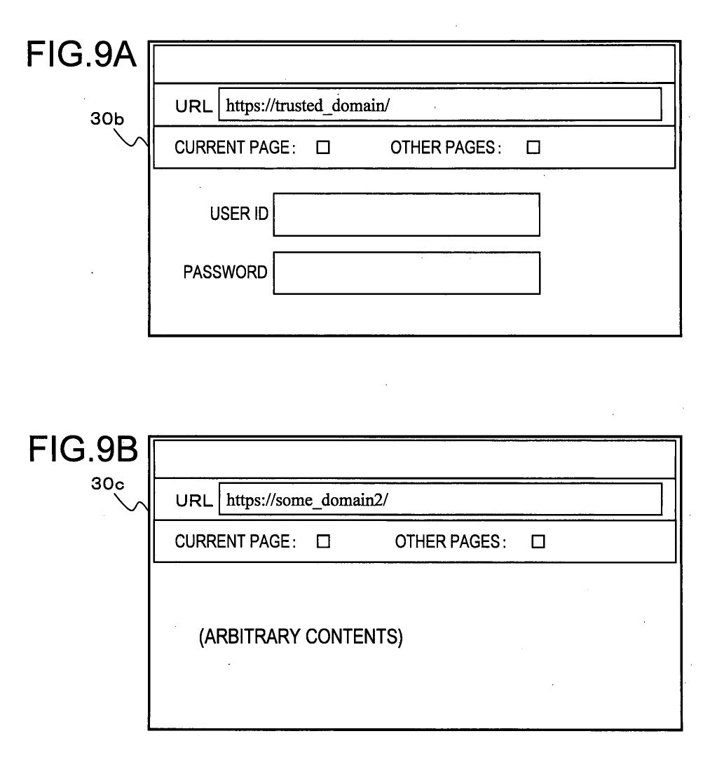

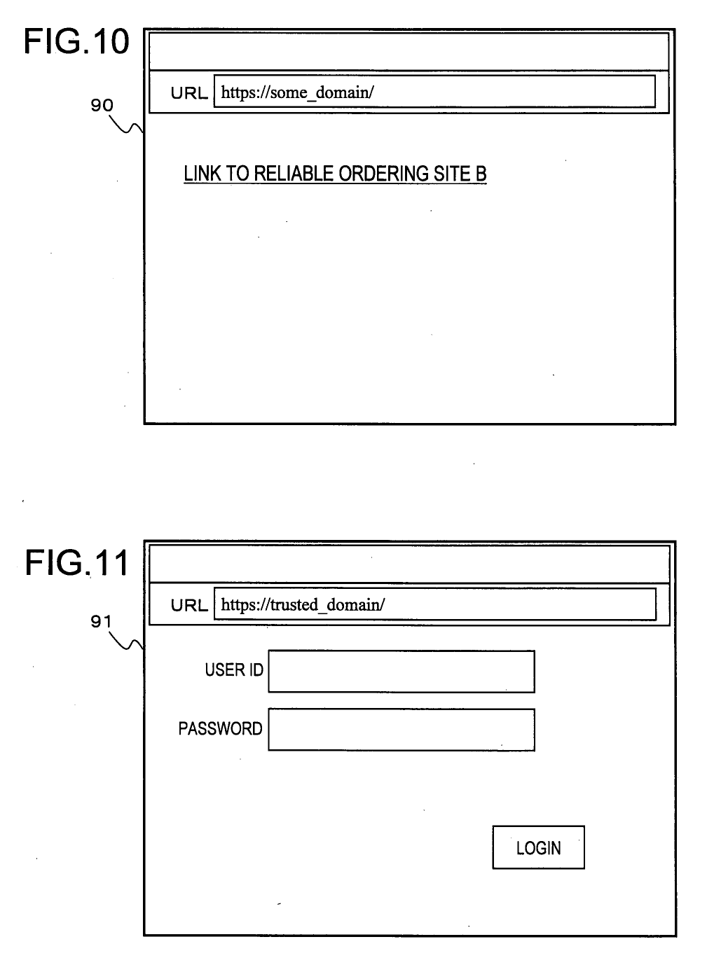

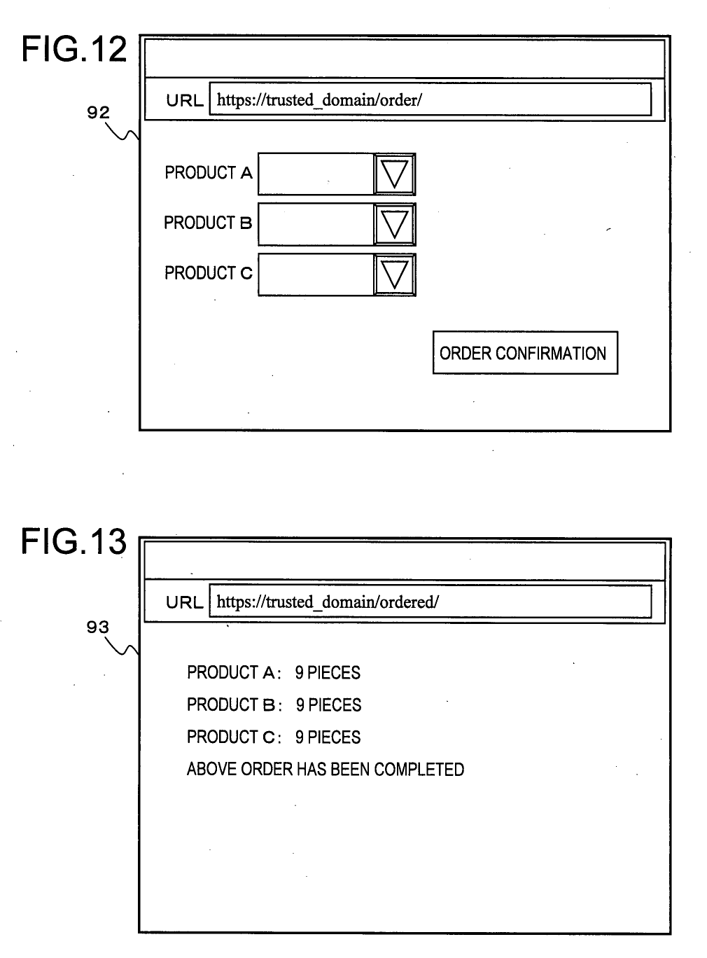

With FIGS. 8 and 9, examples of displaying the non-immediate process existence possibility will be shown.

Here, it is assumed that the Web browser 1 is displaying three different Web pages in display windows 30a, 30b and 30c. It is assumed that a page in the display window 30a shown in FIG. 8(A) is a Web page prepared by an attacker with intent to perform CSRF, including some kind of mechanism of performing processes of the CSRF. Also, it is assumed that a page in the display window 30b shown in FIG. 8(B) and a page in the display window 30c shown in FIG. 8(C) are highly reliable.

The non-immediate process existence possibility detection unit 151 detects the non-immediate process existence possibility with respect to the three Web pages 30a, 30b and 30c managed by the page management unit 101. Since the Web page in the display window 30a includes the mechanism of performing the CSRF, the non-immediate process existence possibility detection unit 151 detects an element capable of executing the non-immediate process and outputs “Possibility=Yes”.

On the other hand, it is assumed that the non-immediate process existence possibility detection unit 151 detects no element capable of executing the non-immediate process from the Web pages in the display windows 30b and 30c. The non-immediate process existence possibility detection unit 151 outputs “Non-immediate Process Existence Possibility=No” with respect to the Web pages in the display windows 30b and 30c.

In response to the output result from the non-immediate process existence possibility detection unit 151, the non-immediate process existence possibility management and display unit 153 displays an icon showing “Non-immediate Process Existence Possibility=Yes” (shown with a black circle) at “Current Page” and an icon showing “Non-immediate Process Existence Possibility=No” (shown with a white rectangle) at “Other Pages” in the display window 30a, as shown in FIG. 8(A).

In addition, since the Web page in the display window 30b is “Non-immediate Process Existence Possibility=No”, the non-immediate process existence possibility management and display unit 153 displays the icon showing “Non-immediate Process Existence Possibility=No” at “Current Page” in the display window 30b, as shown in FIG. 8(B). Moreover, since the Web page in the display window 30a is “Non-immediate Process Existence Possibility=Yes”, the non-immediate process existence possibility management and display unit 153 displays the icon showing “Non-immediate Process Existence Possibility=Yes” at “Other Pages”.

Similarly, since the Web page in the display window 30c is “Non-immediate Process Existence Possibility=No”, the non-immediate process existence possibility management and display unit 153 displays the icon showing “Non-immediate Process Existence Possibility=No” at “Current Page” and the icon showing “Non-immediate Process Existence Possibility=Yes” at “Other Pages” in the display window 30c, as shown in FIG. 8(C).

Thereby, the user can see these icons displayed in the active display window to recognize whether or not there is any risk of the CSRF in the Web page on which he is currently operating or the Web pages being displayed in other display windows.

In a status shown in FIG. 8, even if the Web page in the display window 30b is secure, the user should refrain from performing a task requiring resistance to CSRF attacks. The user can see the displayed non-immediate process existence possibility to recognize that there is the risk of the CSRF in the Web pages in other display windows. Thereby, prior to performing an operation such as login in the display window 30b, the user can perform another operation such as closing the display window 30a having the non-immediate process existence possibility or the like to address the CSRF.

Then, it is assumed that the user noticed the risk of the CSRF and closed the display window 30a. At this point, since no element capable of executing the non-immediate process is detected from the Web pages in the display windows 30b and 30c, the non-immediate process existence possibility detection unit 151 outputs “Non-immediate Process Existence Possibility=No”.

Since the Web page in the display window 30b is “Non-immediate Process Existence Possibility=No”, the non-immediate process existence possibility management and display unit 153 displays the icon showing “Non-immediate Process Existence Possibility=No” at “Current Page” in the display window 30b, as shown in FIG. 9(A). Moreover, since the Web page in the display window 30c is also “Non-immediate Process Existence Possibility=No”, the non-immediate process existence possibility management and display unit 153 displays the icon showing “Non-immediate Process Existence Possibility=No” at “Other Pages”.

Similarly, since the Web page in the display window 30c is “Non-immediate Process Existence Possibility=No”, the non-immediate process existence possibility management and display unit 153 displays the icon showing “Non-immediate Process Existence Possibility=No” at “Current Page” and the icon showing “Non-immediate Process Existence Possibility=No” also at “Other Pages”, respectively in the display window 30c, as shown in FIG. 9(B).

The user can see changes in the icons in the display windows shown in FIG. 9 to know that there is no risk of the CSRF in all Web pages being currently displayed.

In this way, according to the present invention, it is possible to make the user constantly conscious of the possibility of the existence of the non-immediate process capable of performing a process irrelevant to the user's intention, after the Web page is onloaded on the Web browser. Therefore, it can be expected that damage to the user may be prevented from occurring.

As described above, although the present invention has been described with its embodiments, various variations of the present invention are naturally possible within the range of the gist of the present invention.

What is claimed is:

1. A non-immediate process existence possibility display processing program product for causing an apparatus which performs a WWW document display process to execute:
a detection process of detecting a predetermined element capable of performing a non-immediate process that executes a process having contents unintended by a user at an arbitrary timing, from an obtained Web page; and
a display process of, if said element has been detected from said Web page in said detection process, displaying a non-immediate process existence possibility in a display window in which said Web page is being displayed.

2. The non-immediate process existence possibility display processing program according to claim 1, for causing said apparatus to execute processes of:
if there are multiple Web pages being displayed, detecting said element for each Web page in said detection process; and
displaying the non-immediate process existence possibility in said display window for each of a Web page operated by said user and other Web pages among said multiple Web pages, in said display process.

3. The non-immediate process existence possibility display processing program product according to claim 1, for causing said apparatus to execute processes of:
if there are multiple Web pages being displayed, detecting said element for each Web page in said detection process; and
displaying the non-immediate process existence possibility for each of said multiple Web pages in said display window in said display process.

4. The non-immediate process existence possibility display processing program product according to claim 1, for causing said apparatus to execute a process of:
detecting an element related to a timer setting as said element from said Web page in said detection process.

5. The non-immediate process existence possibility display processing program product according to claim 1, for causing said apparatus to execute a process of:
detecting a predetermined embedded object as said element from said Web page in said detection process.

6. The non-immediate process existence possibility display processing program product according to claim 1, for causing said apparatus to execute a process of:
detecting an element related to a predetermined event handler as said element from said Web page in said detection process.

7. The non-immediate process existence possibility display processing program product according to claim 1, for further causing said apparatus to execute:
a detection target non-immediate process target setting process of setting the predetermined element capable of performing the non-immediate process that executes the process having the contents unintended by the user at the arbitrary timing, which is detected in said detection process, based on information inputted by the user.

8. A non-immediate process existence possibility display processing apparatus comprising:
a detection unit for detecting a predetermined element capable of performing a non-immediate process that executes a process having contents unintended by a user at an arbitrary timing, from a Web page being displayed in an apparatus which performs a WWW document display process; and
a display processing unit for, if said element has been detected from said Web page, displaying a non-immediate process existence possibility in a display window in which said Web page is being displayed.

9. The non-immediate process existence possibility display processing apparatus according to claim 8, wherein
if there are multiple Web pages being displayed, said detection unit detects said element for each Web page; and
said display processing unit displays the non-immediate process existence possibility in said display window for each of a Web page operated by said user and other Web pages among said multiple Web pages.

10. The non-immediate process existence possibility display processing apparatus according to claim 8, wherein
if there are multiple Web pages being displayed, said detection unit detects said element for each Web page; and
said display processing unit displays the non-immediate process existence possibility for each of said multiple Web pages in said display window.

11. The non-immediate process existence possibility display processing apparatus according to claim 8, further comprising:
a detection target non-immediate process target setting unit for setting the predetermined element capable of performing the non-immediate process that executes the process having the contents unintended by the user at the arbitrary timing, which is detected by said detection means, based on information inputted by the user.

12. A non-immediate process existence possibility display processing method performed by an apparatus which performs a WWW document display process, the method comprising:
a detection process step of detecting a predetermined element capable of performing a non-immediate process that executes a process having contents unintended by a user at an arbitrary timing, from a Web page being displayed in said display processing apparatus; and
a display process step of, if said element has been detected from said Web page in said detection process step, displaying a non-immediate process existence possibility in a display window in which said Web page is being displayed.

13. The non-immediate process existence possibility display processing method according to claim 12, wherein
if there are multiple Web pages being displayed, said detection process step detects said element for each Web page; and
said display process step displays the non-immediate process existence possibility in said display window for each of a Web page operated by said user and other Web pages among said multiple Web pages.

14. The non-immediate process existence possibility display processing method according to claim 12, wherein
if there are multiple Web pages being displayed, said detection process step detects said element for each Web page; and
said display process step displays the non-immediate process existence possibility for each of said multiple Web pages in said display window.

15. The non-immediate process existence possibility display processing method according to claim 12, further comprising:
a detection target non-immediate process target setting process step of setting the predetermined element capable of performing the non-immediate process that executes the process having the contents unintended by the user at the arbitrary timing, which is detected in said detection process step, based on information inputted by the user.
